(19) United States
(12) Patent Application Publication
(10) Pub. No.: US 2026/0124812 A1
(43) Pub. Date: May 7, 2026

(54) METHOD FOR PRODUCING COMPOSITE PREFORMS

(71) Applicant: steptics GmbH, München (DE)

(72) Inventor: Daniel Kun, München (DE)

(73) Assignee: steptics GmbH, München (DE)

(21) Appl. No.: 19/116,543

(22) PCT Filed: Sep. 22, 2023
(86) PCT No.: PCT/EP2023/076309

§ 371 Date: Mar. 28, 2025

(30) Foreign Application Priority Data
Sep. 29, 2022 (DE) 10 2022 125 198.5

(51) Int. Cl. B29C 70/32; B29C 70/52; B29C 70/54; B29L 31/00

(52) U.S. Cl. CPC B29C 70/32; B29C 70/528; B29C 70/545; B29L 2031/7532

(57) ABSTRACT

The present invention relates to a method for producing composite preforms, in particular prosthesis composite preforms, which comprise fiber-reinforced plastics material, the method comprising a step of producing a multilayer laminate using a wet winding process which comprises forming a plurality of layers by winding at least one impregnated fiber onto a winding core; a step of detaching the laminate from the winding core; a step of reshaping the laminate such that the laminate has at least one predetermined curvature; and a step of consolidating the laminate in order to obtain a composite preform. The invention further relates to a method for producing composite preforms and to a composite preform.

### DESCRIPTION

The present invention relates to a method for producing composite preforms, in particular prosthesis composite preforms, which comprise fiber-reinforced plastics materials. The invention furthermore relates to a device for producing said composite preforms.

Prostheses of all types, and in particular foot prostheses, have been continuously developed over recent years, in order to be able both to individually adjust them to the requirements of a patient in question and also to improve the performance and durability of the prostheses. Said prostheses must have a high degree of strength and resilience, while their own weight is advantageously as low as possible. This is made possible inter alia by carbon fiber reinforced plastics material (CRP), which has already long been used in the production of prostheses. CRP is a composite material which comprises carbon fibers embedded in a plastics matrix. In this case, the corresponding plastics matrix is routinely formed by epoxy resin.

Prostheses preforms produced from CRP have a layered structure, in which a plurality of individual CRP or fiber layers is laid one on top of the other in a layered manner, until a desired material thickness is achieved. This production method is advantageous in particular because the material thickness of produced preforms can be flexibly adjusted in portions, and furthermore the arrangement and the orientation of individual fiber layers can also be influenced. This makes it possible in particular to set a desired strength and resilience of a prosthesis preform. Consequently, specific properties of a foot prosthesis, for example its energy intake, damping factor, bending, and energy output, which are of essential importance for movement sequences during walking, are already configured purposefully when producing the CRP preforms. Thus, for example EP 3 193 789 B 1 discloses a foot prosthesis of variable stiffness, the corresponding foot prosthesis comprising an elongate foot element and a heel element. The elongate foot element and the heel element are interconnected by screw connections and thus imitate the shape of a human foot. The rigidity and flexibility of the foot prosthesis is furthermore essentially determined by the interaction of the elongate foot element and the heel element.

Since the requirements of a prosthesis with respect to its size and function may differ significantly depending on the patient, said prostheses are typically produced by hand. However, this is very time-consuming and costly. Accordingly, it is generally sought to simplify the manufacture of prostheses, such that in particular the preforms of a prosthesis consisting of CRP can be produced on an industrial scale. In this regard, DE 10 2014 213 294 B 4 discloses a method in which foot prosthesis composite preforms made of CRP can be produced by means of what is known as a wet winding method. For this purpose, in a first step a plurality of layers of at least one carbon fiber impregnated with epoxy resin is wound around a winding core or winding mandrel, in order to produce a multilayer laminate. Thereupon, the laminate consolidates on the winding core or can be consolidated in an accelerated manner by means of heat treatment, such that a cured, dimensionally stable material results, which has the shape of the winding core, i.e. is in particular cylindrical or oval. The process of consolidation involves curing the epoxy resin, as a result of which a solid plastics matrix composite material is produced, in which the carbon fiber is embedded. Subsequently, the consolidated laminate is released from the winding core and separated for further processing into a plurality of prosthesis composite preforms of predetermined shape.

However, a disadvantage of the described production method is that the shape of the prosthesis composite preforms is specified by the winding core. In order to allow for efficient winding of the carbon fiber onto the winding core, the winding core must have a steady curvature, i.e. in particular be cylindrical or oval. Consequently, the consolidated laminate merely has a curvature identical to the winding core, as a result of which the shaping of the prosthesis composite preforms to be produced is greatly limited. In particular, in the case of some prostheses it may be necessary for there to be at least one change of curvature in portions. For example, a flexible heel portion of a foot prosthesis can comprise both a concave and a convex region. However, such prosthesis composite preforms cannot be produced by the method described above.

The object of the present invention is therefore that of providing a method for producing composite preforms, in particular prosthesis composite preforms, which allows for particularly simple and time-efficient production of a plurality of composite preforms of variable shaping. A further object of the invention is that of providing a device which is designed for producing composite preforms according to the method according to the invention.

This object is achieved according to the invention in a first aspect by a method for producing composite preforms, in particular prosthesis composite preforms, which comprise fiber-reinforced plastics material, the method comprising a step of producing a multilayer laminate using a wet winding process which comprises forming a plurality of layers by winding at least one impregnated fiber onto a winding core; a step of detaching the laminate from the winding core; a step of reshaping the laminate such that the laminate has at least one predetermined curvature; and a step of consolidating the laminate in order to obtain a composite preform, the method steps according to the invention preferably being intended to be performed in the specified order.

Said wet winding process can in particular be a process according to the wet winding method described at the outset, i.e. that a fiber or a fiber thread or a yarn, which are also referred to in this connection as rovings, is conducted through a liquid or viscous polymer-based resin for impregnation. In addition to epoxy resin, vinyl ester resins, vitrimer resins and/or other polymers, for example elastomers or duromers, can be used for impregnating the fibers used. In this case, it is also conceivable for a pre-impregnated fiber to be used as the starting material. Accordingly, the fiber does not necessarily have to be impregnated in the course of the method according to the invention, but rather can be present in the form of a pre-impregnated roving or a pre-impregnated fiber. Such pre-impregnated rovings, which are also referred to as “Towpreg,” are commercially available.

Subsequently, the impregnated fiber is wound onto a winding core, the fiber being able to be fastened, for this purpose, at one fiber end to the winding core, and being rolled or wound onto this in a controlled manner in the course of a rotation of the winding core. Alternatively, the winding core can also be wound around the fiber. Advantageously, a plurality of fibers can be wound onto the winding core at the same time and at high speed and be combined in a precise manner, with the result that the wet winding method represents an extremely time-efficient and productive production method. Furthermore, this method can be carried out in a fully automated manner or by machine, such that the composite preforms can be produced particularly easily and thus cost-effectively.

According to the invention, in the course of the wet winding process the continuous winding of a fiber onto the winding core results in a homogeneous and multilayer laminate which has a fiber architecture surrounded by a viscous polymer matrix and is therefore classed as a composite material. For this purpose, in general a first fiber layer is formed, which covers a lateral surface of the winding core. A second layer can then be wound onto the first layer, such that the two layers are arranged directly adjacently to one another and thus create the layer-like structure of the laminate. In this case, the winding of the fiber can in particular be carried out according to the peripheral winding method or the cross-winding method. In the case of the peripheral winding method, the impregnated fiber is wound continuously along the main extension direction of the winding core within a layer, such that the lateral surface of the winding core is covered substantially completely by a first wound layer. In this case, the fiber windings that are in each case oriented in parallel with one another within a layer contact one another continuously in the peripheral direction. In contrast thereto, in the case of what is known as the cross-winding method, a first fiber layer is wound onto the winding core at a first specific angle, and a following second fiber layer is wound onto the winding core at a second specific angle, it being possible for the second specific angle to deviate from the first specific angle by +/−30°-60° such that, viewed in the radial direction, two fiber layers wound over one another have a substantially cross-shaped pattern.

Depending on the desired strength or thickness of the laminate to be produced, further layers can be wound onto the already existing layers, such that the thickness of the laminate can be precisely controlled by the number of layers. A preferred thickness of the laminate after detachment from the winding core, i.e. when the laminate is in particular spread out flat, can for example be 1 mm to 12 mm. In addition to the number of layers, and thus the thickness of the laminate, its dimensions in the main extension direction of the winding core can also be set as desired, such that a plurality of composite preforms can be manufactured from a laminate created in a single wet winding process.

According to an important feature of the present invention, the detachment of the wound multilayer laminate takes place immediately after the step of creating the laminate, i.e. immediately after winding of the impregnated fiber onto the winding core, and thus at a timepoint at which the created laminate is not yet consolidated. It follows from this that the method according to the invention differs from the known wet winding method described at the outset for producing prosthesis composite preforms in particular by the timepoint of the detachment of the laminate from the winding core. While in the conventional method the wound laminate is consolidated on the winding core for shaping, according to the invention the laminate is preferably detached from the winding core before consolidation of the laminate. In this connection, the process of detachment is understood to be separation or cutting off of the laminate, manually or by machine, such that said laminate can be removed from the winding core substantially without loss of material.

The detachment of the multilayer laminate from the winding core before the step of consolidation in particular has the advantage that the detached laminate is still soft or dimensionally instable at room temperature, and thus a significant degree of freedom in the shaping of the composite preforms produced from the laminate is made possible. In contrast thereto, the shape of the composite preforms according to the known wet winding method is influenced, and thus limited, substantially by the shape of the winding core, by the consolidation of the laminate on the winding core.

In the method according to the invention, the reshaping of the laminate takes place after the step of detaching the laminate. In this connection, reshaping of the laminate is to be understood as transferring the planar or flat initial shape of the detached laminate into a predetermined shape, said shape preferably corresponding at least in portions to the shape of a prosthesis. In other words, the soft, non-consolidated laminate can be shaped into a prosthesis composite preform. According to the invention, for this purpose the laminate has at least one predefined curvature, which in particular contributes to improving the damping and bending properties of a prosthesis manufactured from the laminate. Advantageously, the reshaping of the laminate takes place in a reshaping unit designed especially for this purpose, which is capable of reshaping the laminate and maintaining the shape obtained in the process, for example by means of pressurized complementary countersurfaces.

Finally, the reshaped laminate detached from the winding core is consolidated for creating a composite preform, in order to fix the shape of the multilayer laminate obtained during the reshaping. In this case, as already mentioned, the viscous polymer matrix of the laminate is consolidated by means of heat treatment, for example by hot pressing, such that a dimensionally stable composite material results. In particular the step of consolidation can also include a cooling process, in order to cool the previously pressure-and heat-treated laminate. Advantageously, the cooling of the laminate takes place uniformly over its entire extension, in order to prevent the formation of thermal stresses within the laminate. The consolidation of the laminate creates a fiber structure embedded in a dimensionally stable polymer matrix, the consolidated laminate constituting a fiber-reinforced plastics material.

Alternatively it is also conceivable that the winding core is designed, in the course of the method according to the invention, for already reshaping the laminate in the wound state, for example using flexible shaping elements on the surface of the winding core, which are capable, in combination with external, complementary countersurfaces, of transferring the laminate into a predetermined shape. In this case, the step of consolidating the laminate could also be carried out in the wound state of the laminate, whereupon the laminate is detached from the winding core in the consolidated state and subsequently separated for further processing into at least one prosthesis composite preform.

In order to create a laminate that is as homogeneous as possible, during the wet winding process, which laminate can subsequently be particularly easily further processed into composite preforms, advantageously a first layer of impregnated fiber wound onto the winding core can contact at least one second layer of impregnated fiber neighboring the first layer, over its entire extension. Of course, all further layers, i.e. in particular a third layer, which is wound onto the second layer, etc., contact their respectively adjacent layers. In this connection, the term “contact” is to be understood to be substantially complete, planar overlapping of one layer with respect to its immediately adjacent layer, such that a particularly homogeneous and compact fiber architecture can be produced. In other words, the individual fiber layers can directly adjoin one another, as a result of which particularly high binding forces between the individual wound layers can be achieved.

Optionally, a first layer of impregnated fiber can be wound at a first specific angle relative to the winding core, and a second layer of impregnated fiber can be wound at a second specific angle relative to the winding core, which second angle deviates from the first specific angle, and all the specific angles being between 0° and 90° relative to the peripheral direction of the winding core. In this case, the specific angle, which is also referred to as the deposition angle or winding angle, can be varied depending on the layer, in order to form a fiber architecture having predetermined properties. Thus, in particular the flexibility of the composite preform to be produced can be influenced by the orientation of the individual layers within the fiber architecture of the laminate. A consolidated laminate, which predominantly comprises fiber layers arranged in parallel with the main extension direction of the laminate, can for example have increased flexibility transversely to the main extension direction. Alternatively, it is also conceivable for the specific angles of the first layer and of the second layer to be identical or substantially identical.

In a preferred embodiment of the method according to the invention, the detachment of the laminate from the winding core can be carried out by separating the laminate substantially in parallel with and/or transversely to a longitudinal axis of the winding core. The corresponding separation of the laminate in parallel with the longitudinal axis of the winding core makes it possible in particular for a substantially rectangular laminate to be created, which is subsequently further processed by reshaping. Optionally, the separation of the laminate can be carried out at the same time both in parallel with and singly or multiple times transversely to the longitudinal axis of the winding core, such that a plurality of uniform laminate blanks is obtained from a single would laminate, in the course of the separation.

In a further preferred embodiment, the laminate or a laminate blank can be cut to size in a predetermined shape before the step of reshaping. As a result, specifically shaped laminate blanks can be produced, which can be further processed, in the course of the further method steps, into composite preforms. In this connection, the term “laminate blanks” refers both to laminates which are cut to size directly on the winding core, and to laminates which are transferred into a predetermined shape before the step of reshaping. The secondary step of cutting to size is expedient in particular if the laminate blanks are intended to be of a shape, even before reshaping, which cannot be achieved or can be achieved only with difficulty in the course of detaching the laminate from the winding core.

The laminate blanks are preferably cut to size uniformly, as a result of which in particular a plurality of rectangular laminate blanks can be manufactured from one laminate. Thus, the following reshaping of the laminate blanks can be simplified, in particular in the case of automatic or machine reshaping, since all the laminate blanks are of the same shape and consequently can be processed in an identical manner. Alternatively, the laminate blanks can be cut to size into shapes deviating from one another, for example into differently dimensioned rectangular, round and/or oval shapes. This makes it possible to manufacture differently shaped composite preforms from one laminate, such that consequently all the composite preforms required for producing a prosthesis can be formed in the course of a single wet winding process. At this point it is noted that, with respect to the following method steps, a laminate and equally a laminate blank can be used. Accordingly, in the following section the term “laminate” also includes a laminate blank.

Optionally, the laminate can comprise at least one concave portion and at least one convex portion due to the reshaping, as a result of which the laminate has at least one curvature change. In this connection, a portion is to be understood as a region of the laminate which can extend both longitudinally and transversely with respect to the main extension direction of the laminate and can have predetermined dimensions. Furthermore, a concave portion does not necessarily have to be provided having the same dimensions as a convex portion, since in particular in the case of foot prostheses it may be necessary for a single prosthesis composite preform to be formed having a plurality of concave and convex portions, in order to imitate the functionality and optionally the shape of a human foot as precisely as possible. Specifically, at this point reference is made to the bottom of the foot, which has a change of curvature in each case for example in the transition regions between the tarsus, i.e. the heel region, the midfoot, and the forefoot. The described method makes it possible to produce specific prostheses composite preform which can precisely reproduce the curvature course of the bottom of the foot. At this point, it is additionally noted that the reshaping of the laminate is not limited to the formation of concave and convex portions. Rather, in the course of the reshaping, the laminate can be transferred into all conceivable shapes that are relevant for the construction of a prosthesis. For example, the reshaped laminate can comprise portions at right-angles to one another. Furthermore, it can already be provided at the time of reshaping to form at least one notch, a slit, and/or a tapered portion in or on the laminate.

In an advantageous embodiment of the method according to the invention, the laminate can be held by a receiving surface during the reshaping, and it being possible for the consolidation of the laminate to be performed while the receiving surface holds the laminate. The receiving surface can in particular be a surface or a portion of the above-mentioned reshaping unit, which is designed for reshaping the laminate detached from the winding core and/or the laminate blanks. For this purpose, in particular a countersurface that is complementary to the receiving surface can be provided, which, in combination with the receiving surface, specifies a predetermined shape for the laminate. The laminate or one or possibly more laminate blanks can be fastened simultaneously to said receiving surface, such that they do not slip in an undesired manner during reshaping.

Since both the reshaping and the consolidation can be carried out while the laminate is held by the receiving surface, the reshaping and the consolidation can advantageously be carried out simultaneously. For this purpose, it can be provided that pressure and temperature can act on the receiving surface and optionally the complementary countersurface, in order to bring about hot pressing of the laminate. Owing to the described procedure, in particular the duration of the production method of a composite preform is reduced and the handling of the reshaped laminates is simplified, since these do not have to be brought into a separate consolidation unit after reshaping. Alternatively, however, it is also conceivable for the reshaping and the consolidation of the laminate to take place in two temporally offset processes.

In a further advantageous embodiment, the laminate can be cooled for storage after the step of reshaping, preferably at a temperature of 10to −100 ° C., particularly preferably at a temperature of-15 to −30° C. In other words, the laminate is cooled or deep-frozen after detachment from the winding core and optionally after creating the laminate blanks, as a result of which the material, which is dimensionally instable or non-rigid at room temperature can be temporarily stored for a longer time period. Thus, advantageously, laminate can be pre-produced at any time by means of the described wet winding process and can be heated or thawed and subsequently further processed as required, i.e. as soon as there is a specific order for producing prosthesis composite preforms. Furthermore, it can also be provided that the laminate is further processed in the cooled state, i.e. in particular reshaped and consolidated.

Alternatively thereto, the laminate can be cooled after the reshaping step, for storage, preferably at a temperature of 10 to −100° C., particularly preferably at a temperature of −15 to −30° C. In this case, in particular the cooling of the laminate after the reshaping but before the consolidation is to be taken into account, it possibly being advantageous here for the reshaped laminate to cool in its position in the receiving surface or in the reshaping unit, such that the shape of the laminate that is already reshaped but is dimensionally instable at room temperature is not lost in the course of the cooling process. In this connection, it can be provided that the laminate to be cooled, together with the receiving surface and optionally the countersurface that is complementary to the receiving surface, can be removed from the reshaping unit, in order not to have to cool the entire reshaping unit.

Furthermore, the step of consolidation can be carried out at a pressure of 1 to 150 bar, preferably 1 to 120 bar, particularly preferably 1 to 40 bar, and at a temperature of 0 to 300° C., preferably 20 to 200° C., particularly preferably 40 to 120° C., over a time period of 10 s to 30 min, preferably 30 s to 20 min, or over a time period of 3 min to 40 min. In this respect, the corresponding parameters can be adjusted depending on the polymer used and depending on the fiber used, in order to ensure optimal curing of the polymer matrix. For example, the consolidation time for fast-curing polymers may be merely a few seconds, while slow-curing polymers can be cured over a time period of several minutes. Consequently, in order to save energy costs, it is advantageous to use a polymer which has short curing times or cures already at low pressures and temperatures.

In a preferred embodiment of the method according to the invention, the at least one fiber can comprise a carbon fiber, a glass fiber, an aramid fiber, a basalt fiber, a ceramic fiber, a natural fiber, or a combination thereof. The type of fiber has a significant influence on the material properties and on the weight of the fiber-reinforced plastics material, and thus also on the functionality of the composite preform to be produced. In particular the strength and resilience of the composite preform is specified by the fibers used and their fiber architecture, i.e. their arrangement and orientation in the polymer matrix. In this connection, in particular the use of carbon fibers should be highlighted, since carbon fibers, in particular anisotropic carbon fibers have high strength and rigidity with a simultaneously low ultimate strain in the axial direction. At this point, it should also be noted that instead of a fiber it is also possible to use a fiber thread, a fiber bundle, a filament, a roving, or optionally a combination thereof, in the course of the wet winding process. A roving is a fiber bundle, the individual filaments of which are oriented in parallel and at the same time are non-twisted and non-spun.

Following the consolidation of the laminate for the production, according to the invention, of a composite preform, this can be post-processed in order to adjust the composite preform at least in portions. In particular a machining method is suitable for this purpose, i.e. processing of the composite preform by means of drilling, milling, and/or grinding. For example, it may be necessary to locally reduce the material thickness of the composite preform or to carry out drilling in order to insert threads into the composite preform.

Furthermore, the object is achieved according to the invention in a second aspect by a device for producing composite preforms, in particular prosthesis composite preforms, which comprise fiber-reinforced plastics material, the device comprising a fiber feed unit which is designed for guiding at least one fiber; a winding core which is typically cylindrical in shape; a winding unit which is designed for winding the fiber onto the winding core in a multilayered manner; a detachment unit which is designed for detaching a laminate, wound onto the winding core, from the winding core; a reshaping unit which is designed for reshaping laminate, detached from the winding core, into a predetermined shape and a receiving surface for the laminate; and a consolidation unit which is designed for producing a composite preform by consolidation of the laminate.

At this point, it should already be noted that all the features relevant for the method according to the invention are also applicable to the device according to the invention, and vice versa.

Optionally, the device according to the invention can be formed having an impregnation unit. The impregnation unit is in particular suitable for impregnating the fiber used, in that the fiber is guided through the impregnation unit before being wound onto the winding core. For this purpose, the impregnation unit can have a reservoir of viscous plastics matrix material, the corresponding plastics matrix material serving for impregnating the fiber. In this connection, reference is furthermore made to the impregnation of the fiber according to the first aspect. If the device according to the invention does not comprise an impregnation unit, then in particular the use of pre-impregnated fibers or pre-impregnated rovings is possible.

The fiber feed unit, the winding core, and the reshaping unit of the device according to the invention are in particular units which are designed to carry out a wet winding process according to the first aspect. In this connection, the fiber feed unit can be designed for uncoiling at least one fiber from a fiber coil, orienting it, and setting a predetermined tension of the fiber.

The task of the winding unit consists in particular in winding the impregnated fibers onto the winding core in a precise manner. For this purpose, it can for example be provided that the winding unit actively winds the fiber around the winding core and/or comprises a guide unit by means of which the orientation or the deposition angle of the fiber on the winding core is specified. In this case, the winding of the fiber onto the winding core can in particular take place by the rotation of the winding core about its longitudinal axis. Furthermore, it can be provided that the winding unit applies a carrier foil to the winding core before winding of the fiber. A carrier foil of this kind serves in particular to protect the winding core and facilitates the detachment of the wound laminate from the winding core.

As already mentioned, according to an important feature of the present invention the laminate created in the course of the wet winding process is detached from the winding core before the reshaping and consolidation. In this connection, the detachment unit of the device according to the invention can be designed to separate the laminate into a plurality of laminate blanks, such that advantageously a plurality of laminate blanks can be obtained from one single wound laminate. On account of this property, in particular the time required for producing composite preforms is improved compared with the manual manufacture mentioned at the outset. The winding core can furthermore comprise a detachable carrier foil on its surface, which foil is designed to simplify the detachment of the laminate from the winding core. If the laminate is removed from the winding core by means of the detachment unit, then the detachment unit detaches the laminate, together with the carrier foil, from the winding core. In this case, the carrier foil, which thereupon extends on one side over the laminate, serves in particular for transporting and handling the laminate and protects it, at least on one side, from contamination.

The device according to the invention can furthermore comprise a plurality of reshaping units and consolidation units, in order to process a plurality of laminates or a plurality of laminate blanks simultaneously. The receiving surface of the reshaping unit can, as already described, comprise a complementary countersurface, such that the laminate can be fixed on both sides during reshaping and a counterpressure required for the reshaping can be applied via the countersurface. Both the receiving surface and the complementary countersurface can be formed having at least one curvature, which is transferred to the laminate in the course of the reshaping.

In a preferred embodiment of the device according to the invention, the detachment unit can comprise cutting means which are designed for cutting the laminate into a predetermined shape. The cutting means can cut the laminate in a fully automatic manner or optionally also be operated manually. The cutting means can be blades or knives, for example rolling knives, carpet knives, and/or ultrasonic knives. The cutting means are in particular designed to cut the laminate into uniform laminate blanks, which have a consistent, rectangular shape.

In a further preferred embodiment, the device can comprise a cooling unit for cooling the laminate. The cooling unit can in particular be a refrigerator and/or a freezer integrated in the device. Alternatively, the cooling unit can also be formed outside of the device according to the invention, for example in the form of a cooling chamber in which a plurality of laminates can be cooled or deep-frozen. As already mentioned, the cooling of the laminate serves in particular for temporary storage, such that laminate can be pre-produced at a given timepoint and cooled or frozen for storage.

In order to create the composite preforms by means of the device according to the invention in as time-efficient a manner as possible, the reshaping unit and the consolidation unit can process a laminate in a combined work step. Accordingly, it may be advantageous for the receiving surface of the reshaping unit to hold the laminate, and it being possible for the consolidation unit to be designed for consolidating the laminate while the laminate is held on the receiving surface. If the laminate is provided having the carrier foil, then the consolidation unit can be designed for removing the carrier foil before the consolidation of the laminate. Alternatively, the carrier foil can also be removed by hand before the reshaping and/or before the consolidation. However, it can also be provided for the carrier foil to remain on the laminate during the reshaping and consolidation.

In a third aspect, the invention furthermore relates to a composite preform, in particular a prosthesis composite preform, which can be produced according to the features of the first aspect, a device according to the second aspect being used for producing said composite preform. Consequently, all the features and embodiments of the method according to the invention and of the device according to the invention can be transferred to the composite preform according to the third aspect. The correspondingly created composite preform can form at least a part of a foot prosthesis or an entire foot prosthesis.

The method according to the invention and the device according to the invention for producing composite preforms, and a composite preform itself, will be described in more detail in the following, with reference to the accompanying drawings, in which:

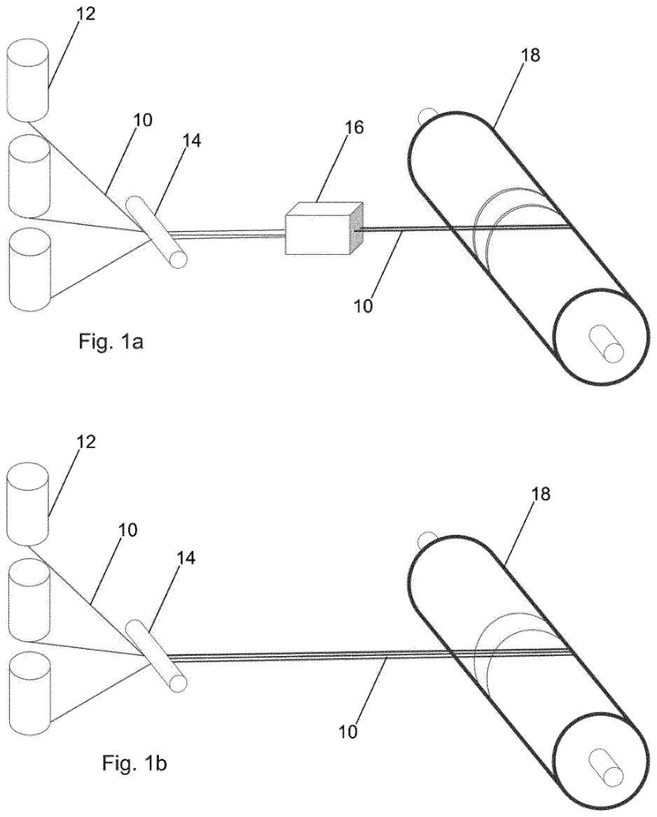

FIG. 1a is an illustration, by way of example, of a wet winding process according to a first embodiment;

FIG. 1b is an illustration, by way of example, of a wet winding process according to a second embodiment;

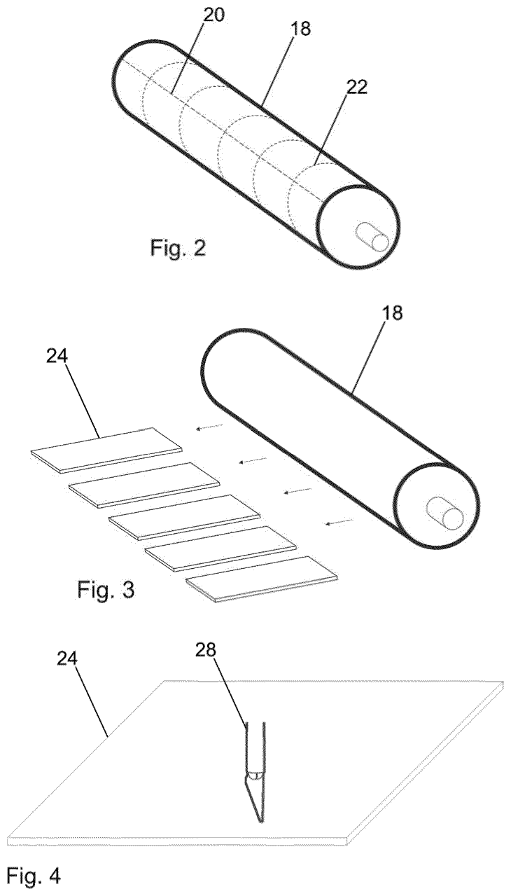

FIG. 2 is a perspective view of a winding core;

FIG. 3 is a perspective view of the winding core with detached laminate blanks;

FIG. 4 is a perspective view of a laminate blank;

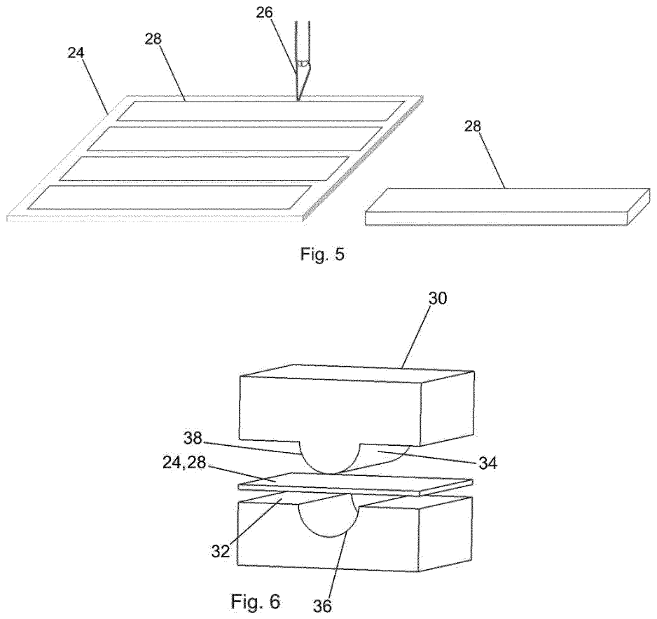

FIG. 5 is an illustration, by way of example, of further processing of the laminate blank from FIG. 4;

FIG. 6 is a perspective view of a reshaping and consolidation unit;

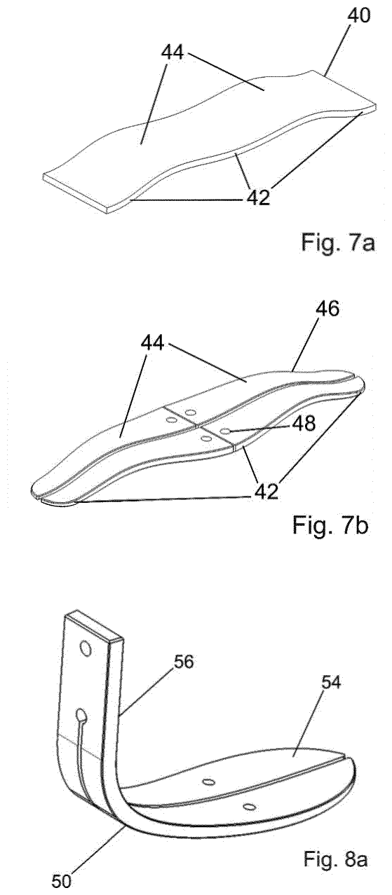

FIG. 7a is an illustration, by way of example, of a composite preform;

FIG. 7b is an illustration, by way of example, of a prosthesis composite preform produced from the composite preform of FIG. 7a;

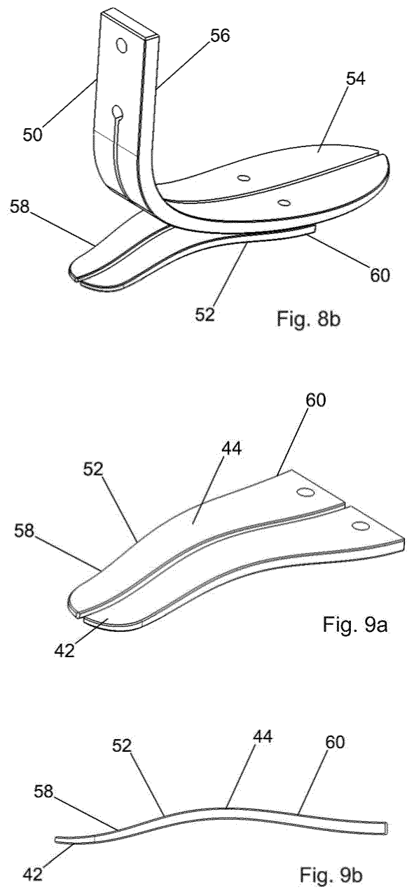

FIG. 8a is a perspective view of a further prosthesis composite preform produced according to the invention;

FIG. 8b is a perspective view of a foot prosthesis which comprises two prosthesis composite preforms produced according to the invention;

FIG. 9a is a perspective view of a prosthesis composite preform of the foot prosthesis from FIG. 8b; and

FIG. 9b is a cross-sectional view of the prosthesis composite preform from FIG. 9a.

The method according to the invention, including advantageous embodiments, is explained in detail in the following figures. The description of the method also includes the illustration of the device according to the invention and its units which can be used for producing composite preforms, in particular prosthesis composite preforms. In this case, the fact that the individual units are sometimes shown and described in isolation in the following is not an obstacle to the invention. Rather, it is noted at this point that the units of the device according to the invention can both be provided as independent units and be integrated in the device according to the invention.

FIG. 1a shows a wet winding process according to a first embodiment, which is suitable, in a known manner, for creating composite materials. For this purpose, in a first step a fiber 10 is provided, which serves as the starting material. The fiber 10 is in particular a carbon fiber, since said carbon-containing material is advantageous for producing functional prosthesis composite preforms due to its high strength and rigidity. Corresponding prosthesis composite preforms are described in detail with reference to FIG. 8a to 9b.

However, instead of carbon fibers other starting materials can also be used here, for example glass fibers, aramid fibers, basalt fibers, ceramic fibers, natural fibers, or a combination thereof. In this case, the selection of the starting material can be made according to the type and functionality of a prosthesis to be produced, and according to the arising material properties and material costs of the starting material. Furthermore, it should again be mentioned at this point that, in the course of the invention, a fiber 10 is also understood to be a fiber thread, a filament, a yarn, or a roving, which are all suitable for use for the wet winding process. In this connection, a roving refers to a bundle, strand or multifilament yarn of filaments arranged in parallel, it being possible for a roving to comprise several thousand filaments.

As shown in FIG. 1a, in the course of a wet winding process a plurality of fibers 10 can be processed simultaneously, in order to increase the efficiency of the wet winding process. The fibers 10 are each provided from a fiber coil 12, from which the fibers 10 are uncoiled by means of a fiber feed unit 14, oriented, and optionally set to a predetermined tension. The fibers 10 are subsequently guided through an impregnation unit 16 which comprises a viscous polymer-based resin. The resin is typically epoxy resin, but the use of other resins or polymers, for example vinyl ester resin, vitrimer resin, elastomers or duromers is also possible. While the fibers 10 are guided through the impregnation unit 16, they are impregnated with the corresponding resin. For this purpose, for example a container filled with viscous or liquid resin can be provided, through which the fibers 10 are guided. Alternatively, a spray system is also conceivable, which sprays the resin onto the fibers 10.

From the impregnation unit 16, the fibers 10 are guided to a rotatably mounted winding core 18, fastened flat thereto, and wound in a purposeful manner onto the winding core 18 by the rotation of the winding core 18. For this purpose, a winding unit (not shown in FIG. 1a) can furthermore be provided, which for example comprises a guide that can be displaced along the winding core 18, by which the fibers 10 can be bundled and purposely wound onto the winding core 18 at a specific position, in particular according to the peripheral winding method or the cross-winding method described at the outset. For this purpose, it can be provided to vary a winding angle or an angle deposition of the fibers 10 relative to the peripheral direction of the winding core 18, in particular in an angular range between 0° and 90°, preferably between 0.2° and 89°, in order to be able to adjust the orientation or the alignment of the fibers 10 during winding onto the winding core 18, and thus to allow for a variable fiber architecture in a laminate to be created by winding, which is merely indicated in FIG. 1a by the individual fibers 10 wound onto the winding core 18. Said fiber architecture of the laminate can consequently comprise a plurality of fiber layers, which each have a predetermined deposition angle. Alternatively, it may also be possible for the winding core 18 to be wound around the fibers 10, it being possible in this case for the winding unit to be designed for controlling the course of movement of the winding core 18 necessary for this purpose.

Preferably, the winding core 18 is coated with a carrier foil before the fibers 10 are wound, as a result of which handling of the laminate is made possible and in particular adhesion of the impregnated fibers 10 to the winding core 18 is prevented. Consequently, contamination of the winding core 18 is prevented. The dimensions of the winding core 18 are furthermore variable depending on the size of the laminate to be produced; in particular, the winding core 18 can be of a length of 0.3 m to 15 m and a diameter of 10 cm to 300 cm. FIG. 1 a shows the winding core 18 with cylindrical shape, it optionally also being possible for the winding core 18 to be of an oval shape. All that is important in this connection is for the shape of the winding core 18 to enable continuous winding, i.e. winding or layering of a plurality of layers of the fibers 10 on the winding core 18 in a winding packet, the fibers 10 to be wound being continuously in contact with the winding core 18 or an already wound fiber layer, in order to create a resistant composite material.

Said composite material is produced in the form of a laminate (not shown in greater detail in FIG. 1 a) by the process of winding the impregnated fibers 10 onto the winding core 18. The laminate comprises the fibers 10 enclosed in a polymer matrix, and thus constitutes a fiber-reinforced plastics material, for example a CRP. In this case, the laminate can consist both of a single fiber material and of different fiber types. The described processes for creating the laminate, and the units involved for this purpose, can all act fully automatically, such that the wet winding method is in particular suitable for manufacturing laminates on an industrial scale.

FIG. 1b shows a wet winding process according to a second embodiment, which differs from the first embodiment shown in FIG. 1a merely by the lack of the impregnation unit 16. Consequently, in this connection, only the differences in FIG. 1b compared with FIG. 1a will be discussed, while for all the common features reference is made to FIG. 1a. In the case of the wet winding process shown in FIG. 1b, fiber coils 12 with pre-impregnated fibers are used, such that the impregnation of the fibers in the course of the wet winding process is omitted.

FIG. 2 now shows the winding core 18 in isolation, said core comprising a wound laminate. The wall thickness or the thickness of a wound laminate can for example be 0.1 mm to 30 mm and is determined in particular by the desired material properties of a prosthesis composite preform to be produced from the laminate. Thus, it may inter alia be preferred to form prosthesis composite preforms, which are intended to withstand high loads, having a comparatively large wall thickness.

The sectional lines 20, 22 shown in FIG. 2 indicate the detachment of the laminate from the winding core 18, specifically in that the laminate is cut by hand or automatically by means of a detachment unit along the lines 20, 22 and subsequently removed from the winding core 18. In this connection, the arrangement of the cutting lines 20, 22 is to be considered to be preferred, i.e. that the laminate is on the one hand separated along the longitudinal axis of the winding core 18 (cutting line 20), as a result of which, if desired, a single laminate can be removed from the winding core 18, and on the other hand the laminate is separated at least once transversely to the longitudinal axis of the winding core 18 (cutting line 22). The latter in particular allows for division of the laminate into a plurality of uniform laminate blanks, which are explained in more detail with reference to FIG. 3. Alternatively, however, it would also be conceivable to separate the laminate in another manner, for example in order to obtain different laminate blanks having varying dimensions. For separating the laminate, cutting means, in particular rolling knives, carpet knives, and/or ultrasonic knives can be used, which are for example controlled by the detachment unit (not shown in FIG. 2). The detachment unit can inter alia be an industrial robot arm which is designed for both cutting the laminate to size along the cutting lines 20, 22 and for removing it from the winding core 18, in order to obtain a plurality of laminate blanks 24. If a carrier foil has been applied to the winding core 18, this advantageously facilitates the removal of the laminate blanks and furthermore protects the winding core 18 from damage by the knives used for separating the laminate.

Said laminate blanks 24 are illustrated in FIG. 3, the laminate blanks 24 shown here having been produced on the basis of the cutting lines 20, 22 shown in FIG. 2, by separation at the winding core 18. This results in rectangular laminate blanks 24 which are all of the same dimensions. Thus, a plurality of laminate blanks 24 can be manufactured from a single wet winding process, which blanks are suitable for further processing into prosthesis composite preforms. The carrier foil, which is also detached when the laminate blanks are removed from the winding core 18, is now located on the underside of the laminate blanks 24 and serves in particular for improved handling, since the laminate blanks 24 can be transported without contamination, by virtue of the carrier foil. Accordingly, the carrier foil is advantageously formed of a flexible material which is pressure-and temperature-resistant, such that the laminate blanks 24 can optionally be reshaped and/or consolidated together with the carrier foil.

In the state shown in FIG. 3, i.e. before the step of reshaping and consolidation, the laminate blanks 24 are dimensionally instable or non-rigid at room temperature, and therefore particularly easily deformable. Optionally, the laminate blanks 24 can now, as illustrated in FIGS. 4 and 5, be cut to size once more, for example in order to adjust the dimensions of a laminate blank 24 at least in portions and/or in order to obtain a plurality of smaller blanks 28 from one laminate blank 24. The cutting to size of the already detached laminate blanks 24 can in particular be performed more easily than the cutting to size of the laminate in the wound state, and therefore the former is particularly advantageous. The cutting to size of the laminate blanks 24 shown in FIGS. 4 and 5 is preferably carried out using the same cutting means 26 as for detaching the detaching the laminate from the winding core 18. At this point, it should also be noted that the laminate blanks 24 can be processed not only by cutting to size, but rather other processing steps are also possible here, for example compressing of the laminate blanks 24 in order to reduce their layer thickness.

FIG. 6 now shows a reshaping unit 30 which is designed for reshaping a laminate blank 24 or a blank 28. In this regard it is noted that a blank 28 can be used in the further course, rather than a laminate blank 24 or also a laminate. However, for reasons of clarity only the term “laminate blank” 24 is mentioned, this term including the use of a laminate and of a blank 28. In this connection, reshaping means in particular that the laminate blank 24 is transferred into a predetermined prosthesis shape. For this purpose, the reshaping unit 30 comprises, here, a receiving surface 32 and a countersurface 34 that is complementary to the receiving surface 32, the two surfaces 32, 34 in turn being formed having shaping elements 36, 38 that are complementary to one another. In this case, the first shaping element 36 is provided by way of example as a concave portion, such that the second shaping element 38 of the complementary countersurface 34 consequently has a convex portion.

For reshaping, the laminate blank 24 is now deposited and optionally fixed on the receiving surface 32 of the reshaping unit 30. The dimensions of the receiving surface 32 preferably correspond to the dimensions of the laminate blank 24, such that the positioning of the laminate blank 24 in the reshaping unit 30 is clearly predetermined. The shaping elements 36, 38 are arranged such that they come into engagement with one another in an exactly fitting manner when the two surfaces 32, 34 are brought together, as a result of which the shape of the shaping elements 36, 38 is transferred to the laminate blank 24. In the embodiment shown of the reshaping unit 30, the convexly formed second shaping element 38 of the countersurface 34 pushes the laminate blank 24 into the concavely formed first shaping element 36 of the receiving surface 32, as a result of which a concave portion is created in the laminate blank 24. It should be emphasized at this point that the shaping elements 36, 38 are shown here merely by way of example. Rather, the shaping elements 36, 38 can be designed according to the type and functionality of the prosthesis to be produced, such that a plurality of prosthesis shapes can be created with the aid of the described method. It should be particularly emphasized in this case that the prosthesis composite preform to be manufactured can in particular have at least one change of curvature, i.e. in particular comprises one concave and one convex portion. For this purpose, the reshaping unit 30 can for example be provided having a plurality of shaping elements 36, 38, in each case arranged offset from one another, on the receiving surface 32 and on the complementary countersurface 34.

If the reshaped laminate blank 24 were now removed from the reshaping unit 30, then there would be a risk of the laminate blank 24 losing its shape entirely or in part, owing to its dimensional instability. In order to prevent this, according to an advantageous embodiment the reshaping unit 30 can be designed for consolidating the laminate blank 24, i.e. the reshaping unit 30 additionally constitutes a consolidation unit. Consequently, the laminate blank 24 can be consolidated directly together or simultaneously with the step of reshaping, such that a dimensionally stable composite preform results. The step of consolidation is in particular a conventional hot pressing process, i.e. a predetermined pressure and a predetermined temperature can be applied to the laminate blank 24 by means of the receiving surface 32 and in particular by means of the complementary countersurface 34, in order to cure the plastics matrix of the laminate blank 24. The pressures and temperatures applied for this purpose vary depending on the plastics matrix material used and are usually in a range of 1 bar to 120 bar, preferably in a range of 1 to 40 bar, and 20° C. to 200° C., preferably 40 to 120° C., it also being possible for a laminate blank to be cooled in the course of the consolidation, for example to 6° C. The consolidation time is typically between 30 s and 20 min or between 3 min and 40 min. If the laminate blank 24 to be reshaped and to be consolidated comprises a carrier foil, then this can optionally be removed before introduction into the reshaping unit 30 or also be reshaped and consolidated together with the laminate blank 24.

Furthermore, it may be desirable to temporarily store the laminate blanks 24 for a certain period of time, i.e. to not process these into composite preforms by consolidation immediately after they have been produced. This may be the case for example if large amounts of starting material, i.e. of fiber and polymer material, are present, but there are not yet any immediate orders for manufacturing composite preforms. In such a case, laminate blanks 24 can be cooled or deep-frozen, for example to −25° C. For this purpose, in particular the reshaping and consolidation unit 30 can comprise a cooling unit, it alternatively also being possible for the laminate blanks 24 to be stored in an external cooling chamber. As soon as the laminate blanks 24 are to be reshaped and consolidated, these can be thawed and correspondingly further processed. Alternatively, cooling of the laminate blanks 24 in the already reshaped state is also conceivable.

FIG. 7 a illustrates a composite preform 40, by way of example, produced according to the described method. Here, the composite preform 40 comprises three concave portions 42 and two convex portions 44, which are in each case arranged in an alternating manner on the composite preform 40 and can be created by correspondingly formed shaping elements 36, 38 of the reshaping and consolidation unit 30. The composite preform 40 shown in FIG. 7 a was manufactured from a single laminate blank 24 and is suitable in particular for use as a prosthesis composite preform 46, which is shown in FIG. 7 b. For this purpose, for example drilled holes 48 can be made in the composite preform 40, in order to provide said preform with threads and to connect it to further prosthesis composite preforms 46 in order to manufacture a complex prosthesis, as illustrated in FIG. 8b. Furthermore, it may be necessary to adjust the shape and/or thickness of the composite preform 40, for producing and optionally individualizing a prosthesis, by means of a machining method, in particular milling or grinding, or by means of punching, water jet cutting or lasering. In this connection, the composite preform 40 may, if desired, be divided into a plurality of segments, in particular into two or four segments, by notches or slits, which are illustrated by way of example on the basis of the embodiments shown in FIGS. 7b, 8a, 8b and 9a, as a result of which inter alia the flexibility of the prosthesis composite preform 46 orthogonally to its main extension direction can be increased. In a further post-processing step, the composite preform 40 can be coated with a sealing layer, which for example comprises a varnish or a polymer layer, in order to seal roughened or porous surfaces.

Analogously to FIG. 7b, FIGS. 8a and 8b show examples for prosthesis composite preforms 50, 52, which are already fully developed and can be produced by means of the described method. In this connection, FIG. 8a shows a first prosthesis composite preform 50 of a foot prosthesis, which is in particular formed having a constant curvature and extends from a forefoot portion 54 to a tibiofibular portion 56. In FIG. 8 b, the first prosthesis composite preform 50 is connected to a second prosthesis composite preform 52, which comprises a heel portion 58 and a midfoot portion 60. In the connected state, the prosthesis composite preforms 50, 52 constitute a functional foot prosthesis consisting of fiber-reinforced plastics material, for example of CRP, such a shape of a foot prosthesis already being known from the prior art, but being able to be created particularly easily and cost-effectively on the basis of the method according to the invention.

FIGS. 9a and 9b now once again illustrate the shape of the second prosthesis composite preform 52, FIG. 9 a being a perspective view and FIG. 9 b corresponding to a cross-sectional view. It can be seen from both figures that the second prosthesis composite preform 52 comprises both a concave portion 42 in the region of the heel portion 58 and a convex portion 44 in the region of the midfoot portion 60. Thus, the prosthesis composite preform 52 shown in FIGS. 8 b, 9 a and 9 b has, analogously to the prosthesis composite preform 46 shown in FIG. 7 b, at least one change of curvature over its respective main extension direction. Such a shape has a positive effect on important properties of a foot prosthesis, in particular on the energy intake, the damping factor, the bending, and the energy output of the foot prosthesis. The method according to the invention, and the device according to the invention, are particularly well suited for producing foot prosthesis composite preforms 46, 50, 52 of this kind, since a high degree of freedom in the shaping and in particular the curvature course of the prosthesis composite preforms 46, 50, 52, with a simultaneously low time requirement, is made possible.

Further aspects and embodiments of the present invention are illustrated on the basis of the following examples:

Example 1: Method for producing composite preforms (40), in particular prosthesis composite preforms (46, 50, 52), which comprise fiber-reinforced plastics material, wherein the method comprises the following steps:
producing a multilayer laminate using a wet winding process, wherein the wet winding process comprises forming a plurality of layers by winding at least one impregnated fiber (10) onto a winding core (18);
detaching the laminate from the winding core (18);
reshaping the laminate such that the laminate has at least one predetermined curvature; and
consolidating the laminate in order to obtain a composite preform (40).

Example 2: Method according to example 1, wherein a first layer of impregnated fiber (10) wound onto the winding core (18) contacts at least one second layer of impregnated fiber (10) neighboring the first layer, over its entire extension.

Example 3: Method according to either of the preceding examples, wherein a first layer of impregnated fiber (10) is wound at a first specific angle relative to the winding core (18) and a second layer of impregnated fiber (10) is wound at a second specific angle relative to the winding core (18), which second angle deviates from the first specific angle, and wherein all the specific angles are between 0° and 90°.

Example 4: Method according to any of the preceding examples, wherein the detachment of the laminate from the winding core (18) is carried out by separating the laminate substantially in parallel with and/or transversely to a longitudinal axis of the winding core (18).

Example 5: Method according to any of the preceding examples, wherein the laminate is cut into a predetermined shape before the step of reshaping.

Example 6: Method according to any of the preceding examples, wherein the laminate comprises at least one concave portion (42) and at least one convex portion (44) due to the reshaping.

Example 7: Method according to any of the preceding examples, wherein the laminate is held by a receiving surface (32) during the reshaping, and wherein the consolidation of the laminate is performed while the receiving surface (32) holds the laminate.

Example 8: Method according to any of the preceding examples, wherein the laminate is cooled for storage before the step of reshaping, preferably at a temperature of 10to −100 ° C., particularly preferably at a temperature of −15 to −30° C.

Example 9: Method according to any of examples 1 to 7, wherein the laminate is cooled for storage after the step of reshaping, preferably at a temperature of 10 to −100° C. , particularly preferably at a temperature of 15 to −30° C.

Example 10: Method according to any of the preceding examples, wherein the step of consolidation is carried out at a pressure of 1 to 150 bar, preferably 6 to 120 bar, and at a temperature of 0 to 300° C., preferably 20 to 200° C., over a time period of 10 s to 30 min, preferably 30 s to 20 min.

Example 11: Method according to any of the preceding examples, wherein the at least one fiber (10) comprises a carbon fiber, a glass fiber, an aramid fiber, a basalt fiber, a ceramic fiber, a natural fiber, or a combination thereof.

Example 12: Device for producing composite preforms (40), in particular prosthesis composite preforms (46, 50, 52), which comprise fiber-reinforced plastics material, wherein the device comprises:
a fiber feed unit (14) which is designed for guiding at least one fiber (10);
a winding core (18) which is of a substantially cylindrical shape;
a winding unit which is designed for winding the fibers (10) onto the winding core (18) in a multilayer manner;
a detachment unit which is designed for detaching a laminate, wound onto the winding core (18), from the winding core (18);
a reshaping unit (30) which is designed for reshaping the laminate, detached from the winding core (18), into a predetermined shape, and comprises a receiving surface (32) for the laminate; and
a consolidation unit which is designed for producing a composite preform (40) by consolidating the laminate.

Example 13: Device according to example 12, wherein the winding unit is furthermore designed to wind a first layer of impregnated fiber (10) onto the winding core (18) in such a way that the first layer contacts at least one second layer of impregnated fiber (10) neighboring the first layer, over its entire extension.

Example 14: Device according to either example 12 or example 13, wherein the winding unit is furthermore designed to wind a first layer of impregnated fiber (10) at a first specific angle relative to the winding core (18) and to wind a second layer of impregnated fiber (10) at a second specific angle relative to the winding core (18), which second angle deviates from the first specific angle, wherein all the specific angles are between 0° and 90°.

Example 15: Device according to any of examples 12 to 14, wherein the detachment unit comprises cutting means (26) which are designed for cutting the laminate into a predetermined shape.

Example 16: Device according to any of examples 12 to 15, wherein the device comprises a cooling unit for cooling the laminate.

Example 17: Device according to any of examples 12 to 16, wherein the receiving surface (32) of the reshaping unit (30) holds the laminate, and wherein the consolidation unit is designed for consolidating the laminate while the laminate is held on the receiving surface (32).

Example 18: Composite preform (40), in particular prosthesis composite preform (46, 50, 52), produced according to a method according to any of examples 1 to 11 and by means of a device according to any of examples 12 to 17.

Example 19: Composite preform (40) according to example 18, wherein the composite preform (40) forms at least a part of a foot prosthesis.

1. Method for producing composite preforms in particular prosthesis composite preforms, which comprise fiber-reinforced plastics material, wherein the method comprises the following steps:
producing a multilayer laminate using a wet winding process, wherein the wet winding process comprises forming a plurality of layers by winding at least one impregnated fiber onto a winding core;
detaching the laminate from the winding core;
reshaping the laminate such that the laminate has at least one predetermined curvature; and
consolidating the laminate in order to obtain a composite preform.

2. Method according to claim 1, wherein a first layer of impregnated fiber wound onto the winding core contacts at least one second layer of impregnated fiber neighboring the first layer, over its entire extension.

3. Method according to claim 1, wherein a first layer of impregnated fiber is wound at a first specific angle relative to the winding core and a second layer of impregnated fiber is wound at a second specific angle relative to the winding core, which second angle deviates from the first specific angle, and wherein all the specific angles are between 0° and 90°.

4. Method according to claim 1, wherein the laminate is cut into a predetermined shape before the step of reshaping.

5. Method according to claim 1, wherein the laminate comprises at least one concave portion and at least one convex portion due to the reshaping.

6. Method according to claim 1, wherein the laminate is held by a receiving surface during the reshaping, and wherein the consolidation of the laminate is performed while the receiving surface holds the laminate.

7. Method according to claim 1, wherein the laminate is cooled for storage after the step of detaching from the winding core and before the step of reshaping, or after the step of reshaping and before the step of consolidation.

8. Method according to claim 1, wherein the step of consolidation is carried out at a pressure of 1 to 150 bar and at a temperature of 0 to 300° C. over a time period of 10 s to 30 min.

9. Method according to claim 1, wherein a thickness of the laminate after the step of detaching from the winding core is between 1 mm and 12 mm.

10. Device for producing composite preforms in particular prosthesis composite preforms which comprise fiber-reinforced plastics material, wherein the device comprises:
a fiber feed unit which is designed for guiding at least one fiber;
a winding core which is of a substantially cylindrical shape;
a winding unit which is designed for winding the fibers onto the winding core in a multilayer manner;
a detachment unit which is designed for detaching a laminate, wound onto the winding core, from the winding core;
a reshaping unit which is designed for reshaping the laminate, detached from the winding core, into a predetermined shape, and comprises a receiving surface for the laminate; and
a consolidation unit which is designed for producing a composite preform by consolidating the laminate.

11. Device according to claim 10, wherein the winding unit is furthermore designed to wind a first layer of impregnated fiber onto the winding core in such a way that the first layer contacts at least one second layer of impregnated fiber neighboring the first layer, over its entire extension, and/or
wherein the winding unit is furthermore designed to wind a first layer of impregnated fiber at a first specific angle relative to the winding core and to wind a second layer of impregnated fiber at a second specific angle relative to the winding core, which second angle deviates from the first specific angle, wherein all the specific angles are between 0° and 90°.

12. Device according to claim 10, wherein the detachment unit comprises cutting means which are designed for cutting the laminate into a predetermined shape.

13. Device according to claim 10, wherein the device comprises a cooling unit for cooling the laminate.

14. Device according to claim 10, wherein the receiving surface of the reshaping unit holds the laminate, and wherein the consolidation unit is designed for consolidating the laminate while the laminate is held on the receiving surface.

15. Composite preform in particular prosthesis composite preform, produced according to a method according to claim 1 and by means of a device for producing the prosthesis composite preform, which comprise fiber-reinforced plastics material, wherein the device comprises:
a fiber feed unit which is designed for guiding at least one fiber;
a winding core which is of a substantially cylindrical shape;
a winding unit which is designed for winding the fibers onto the winding core in a multilayer manner;
a detachment unit which is designed for detaching a laminate, wound onto the winding core, from the winding core;
a reshaping unit which is designed for reshaping the laminate, detached from the winding core, into a predetermined shape, and comprises a receiving surface for the laminate; and
a consolidation unit which is designed for producing a composite preform by consolidating the laminate.
